(19) United States
(12) Patent Application Publication
(10) Pub. No.: US 2025/0038506 A1
(43) Pub. Date: Jan. 30, 2025

(54) DEVICE FOR LEADING AT LEAST ONE LINE THROUGH AN OPENING IN A WALL

(71) Applicant: DOYMA GmbH & Co, Oyten (DE)

(72) Inventors: Florian Straube, Bremen (DE); Philipp Müller, Achim (DE)

(21) Appl. No.: 18/787,276

(22) Filed: Jul. 29, 2024

(30) Foreign Application Priority Data
Jul. 28, 2023 (EP) 23188359.6

(51) Int. Cl. H02G 3/22

(52) U.S. Cl. CPC H02G 3/22

(57) ABSTRACT

A device for leading at least one line through an opening in a wall and/or story ceiling, with at least one pipe element for receiving the line to be led through the opening and at least one end element which can be abutted directly or indirectly against a wall surface of the wall. The end element has a coupling portion facing inwards towards the pipe element. The coupling portion can be brought into abutment or engagement with the outer surface of the pipe element for force-fitting and/or form-fitting coupling. The pipe element and/or the end element may abut the wall and/or story ceiling and are elastically deformable at least axially in the longitudinal direction of the pipe element in such a manner that, in the assembled state, the end element is pressed against the wall.

### CROSS-REFERENCE TO RELATED APPLICATION

This application claims priority to and any benefit of European Application No. 23188359.6, filed Jul. 28, 2023, the content of which is incorporated herein by reference in its entirety.

### FIELD

The invention relates to a device for leading at least one line through an opening in a wall and/or story ceiling, with at least one pipe element for receiving the line to be led through the opening, and at least one end element which can be abutted directly or indirectly against a wall surface of the wall, wherein the end element has a coupling portion facing inwards towards the pipe, wherein the coupling portion can be brought into abutment or engagement with the outer surface of the pipe element for force-fitting and/or form-fitting coupling. Furthermore, the invention relates to a method for installing a device for leading at least one line through an opening in a wall.

### BACKGROUND

Lead-through devices of the aforementioned type, also known as house lead-ins or wall lead-throughs, are used to seal lines, such as media or supply lines, with respect to an opening or cutout in a wall, in particular an approximately vertically extending wall, of a building. According to the invention, a line is understood to mean both electrical lines and lines carrying media, such as gas or water lines or refrigerant lines of heat pump systems or air conditioning systems. A line can be in one piece or consist of one or more line portions. A line is usually led horizontally from the outside into the building through a building wall or vertically through a floor slab or story ceiling. The device is usually arranged inside the cutout in the wall or wall portion and seals against the opening in the wall as well as against the line led therethrough.

Such lead-through devices are generally known for lines that are led through a pipe element extending through the opening in the wall portion. At each of the ends of the pipe element protruding from the wall portion, there is usually an end element which is brought into abutment with a wall surface in each case on one side of the wall. A tensioning force that can be applied manually is usually generated between the end elements arranged on opposite sides of the wall. In this manner, the abutment of the end elements against the wall surfaces is achieved, in particular around the opening.

From DE 10 2013 224 027 B4, for example, such a device for leading lines through an opening in a wall is known. The end elements each have a receptacle for cooperating with the pipe element, by means of which the end elements are fixed at a predetermined distance from one another along the pipe element. To apply a tensioning force between the end elements arranged on both sides of the wall, an expansion body, which can be enlarged in volume and generates the necessary contact pressure, is arranged between an end element and an associated wall surface.

### SUMMARY

Starting from the present prior art, the invention was based on the object of providing a device for leading a line through an opening in a wall, by means of which, in addition to a secure sealing, a simplified assembly, in particular a simplified tensioning of the device with its end element with respect to the wall, is achieved. At the very least, an alternative possibility to the solutions known to date is to be proposed for the configuration of a lead-through device.

The invention achieves its underlying object with a device for leading at least one line through an opening in a wall with the features according to claim 1. In particular, it is provided that the pipe element and/or the end element, which can be abutted against the wall, are/is elastically deformable at least axially in the longitudinal direction of the pipe element, such that in the assembled state, the end element is pressed against the wall due to an elastic deformation of the pipe element and/or on the end element.

In the present case, the invention pursues the approach that the tensioning force required for fixing and, if necessary, sealing the lead-through device with respect to the wall is generated with the aid of an elastic deformation of the pipe element or of the end element which can be brought into abutment with the wall. During elastic tensioning of the device, the pipe element or the end element cooperating with the pipe element is preferably deflected at least in the axial direction in such a manner that, after the lead-through device has been assembled in the opening, restoring forces acting in the axial direction and resulting from the elastic deformation of the pipe element and/or end element generate a force which presses the end element arranged on at least one side of the wall against the wall surface with a predetermined contact force. The end element is preferably assigned a counter bearing at the opposite end of the pipe element, which engages on or is fixed to the opposite wall surface or along a portion in the opening. In this manner, an advantageous fixing of the device within the opening of the wall at two points spaced apart from each other is achieved and, if necessary, a sealing with respect to at least one wall surface of the wall is implemented as a result. Preferably, the final coupling of the end element to the outer surface of the pipe element takes place after the pipe element has been elastically deformed, in particular elongated, in the longitudinal direction, or at least one region on the end element has been deformed by a predetermined minimum amount by bringing it into abutment with the wall surface of the wall. In particular, the coupling portion on the end element engages form-fittingly in corresponding receptacles formed along the pipe element. In an alternative configuration, the coupling portion is force-fittingly fixed to the outer surface of the pipe element, for example via a tensioning means that cooperates with the coupling portion. As a counter bearing for the end element that can be brought into abutment with the wall, a holder comprising multiple support struts and cooperating with the other wall surface of the wall can be arranged at the opposite end of the pipe element. Preferably, such an end element, which can be abutted directly or indirectly against the wall, is arranged on each of the opposite wall surfaces of the wall.

A preferred further development of the invention provides that the coupling portion has at least one coupling element which can be brought into form-fitting engagement with the outer surface of the pipe. The provision of a coupling element for form-fitting engagement with the surface of the pipe element effects a structurally simple means of establishing a connection for force transmission between the pipe element and at least one end element to be held in position along the pipe element. With the aid of the coupling element, a latching function is preferably implemented on the surface of the pipe element, which makes it possible to position the end element preferably in different positions along the pipe element.

In particular, the coupling portion is designed or configured in such a manner that the end element can be slid on in one direction of movement along the pipe element with virtually no resistance, but in the opposite direction, supporting/locking the end element on the pipe element is implemented by mean of the coupling portion. Preferably, the end elements can be slid along the pipe element in the direction of the wall surface, whereas a self-locking locking mechanism is implemented in the opposite direction. As a result, assembling on such a lead-through device designed according to the invention in the region of an opening in a wall is further simplified.

In a preferred further development of the device, it is provided that the pipe element has recesses and/or projections on its outer surface, in particular is designed as a corrugated pipe, and the coupling portion is designed such that the coupling portion corresponds form-fittingly with at least one recess and/or projection. The recesses and/or projections on the surface of the pipe element form structural parts on the pipe element with which the coupling portion of the end element cooperates for positioning the end element along the pipe element. In one possible configuration, the recesses and/or projections on the pipe element are formed at predefined intervals along the pipe element. Preferably, the pipe element is designed as a corrugated tube, so that alternating projections and recesses are formed on the surface in the longitudinal direction. This makes it possible to couple the end element to the pipe element along the surface thereof at relatively small distances from each other without having to form projections and/or recesses specifically on the surface of the pipe element. In addition, the use of a corrugated tube as a pipe element has the advantage that the desired elastic deformability for the elongation of the pipe element in the longitudinal direction is given by the constructional configuration.

In one possible embodiment, the pipe element is designed to be flexible and configured to be laid running at an angle in the range of 0° to 70° to the wall surface of the wall or story ceiling. The pipe element, preferably designed as a corrugated pipe, can be led through an opening in a wall that runs at an angle β inclined to the wall surface of the wall. In an alternative configuration, instead of a corrugated tube, a flexible hose can also be used, which has projections axially spaced apart from one another at predetermined distances along its outer surface in its longitudinal direction, with which the coupling portion on the end element can cooperate.

Preferably, the at least one coupling element is designed as an elastically deformable latching hook, which can be latched to at least one recess on the pipe element. The elastic deformability of the latching hook effects that during the movement of the end element along the pipe element, the latching hook can preferably deflect in a radial direction with respect to a projection on the surface of the pipe element. This ensures that the end element can be moved in at least one direction along the pipe element. At the same time, the elastic deformability of the coupling element effects that the coupling element, once it has passed the projection, automatically comes into engagement again with the outer surface of the pipe element therebehind. Preferably, the latching hook has an end portion which, in the assembled state of the device, engages substantially radially inwards in one of the recesses on the pipe element or, in the case of projections projecting outwards on the outer surface of the pipe element, engages behind them to form a form-fitting connection in the axial direction.

According to a preferred further development, the coupling element extends away from the outside of the end element at an acute angle relative to a longitudinal axis of the pipe element. This effects that when assembling the device, sliding the end element onto the pipe element as described above and thus bringing the end element into abutment with one of the wall surfaces is made easier. The coupling element, in particular an elastically deformable latching hook, is formed tongue-like at the coupling portion and runs at an acute angle, preferably less than 45°, relative to the longitudinal axis of the pipe element. In addition, the described locking/support function according to the invention in the opposite direction of movement to the pipe element and thus a secure transmission of force from the end element to the pipe element is also achieved by means of the coupling element due to its course at the coupling portion at an acute angle to the longitudinal axis of the pipe element.

In a preferred configuration of the device, a multiplicity of coupling elements is arranged on the coupling portion distributed over the circumference of the pipe element, wherein preferably coupling elements of different lengths are provided on the coupling portion. By providing a multiplicity of coupling elements preferably designed as latching hooks, with multiple coupling elements corresponding in each case simultaneously with at least one of the projections and/or recesses on the outer surface of the pipe element, an improved latching function and a uniform force distribution over the circumference of the pipe element is achieved for securely locking the end element relative to the pipe element. In one possible embodiment, the coupling elements are evenly distributed over the circumference of the pipe element.

In one possible configuration, the coupling elements, which are each formed adjacent to one another in the circumferential direction of the pipe element, have different lengths. Preferably, the coupling elements engage in different recesses or cooperate with different projections. Preferably, the end portions of the latching hooks, which are formed in particular in a tongue-like manner, engage at different axial positions along the pipe element with respect to the longitudinal direction of the pipe element.

A further development of the device according to the invention provides that at least two groups of coupling elements are designed with different lengths. In one possible embodiment, the lengths of the different groups of coupling elements are selected such that only one of the groups of coupling elements cooperates with or engages in the recesses and/or projections on the pipe element at any one time. For example, if the coupling elements of a first group cooperate with the recesses or projections on the outer surface of the pipe element, the coupling elements of the second group are arranged between two recesses on the surface of the pipe element or at a distance from a projection formed on the surface of the pipe element. This allows a more finely subdivided support/latching function and more precise positioning of the end element, preferably of the two end elements being used, along the pipe element. In an alternative configuration, multiple coupling elements can alternatively or optionally be arranged axially one behind the other on the coupling portion, wherein these coupling elements can be of the same or different lengths on the coupling portion.

According to a preferred embodiment of the present invention which, at the same time, also illustrates a separate aspect of the invention, an at least partially elastically deformable collar is provided with at least two axially adjoining sealing portions having cross-sections of the same or different sizes, which can be brought into abutment, preferably sealingly, with one of the end elements on the one hand and with the outer surface of the pipe element on the other hand. The collar used on the device according to the invention serves in particular to seal between the transition from the end element to the pipe element. This counteracts the penetration of moisture via the connection region between the pipe element and the coupling portion and thus into the wall-side region of the end element of the device and into the opening in the wall portion and into the interior of the wall portion. Preferably, fluidproofing in accordance with DIN 18533, which prevents the passage of fluid, such as water, is achieved by means of the collar which is used as a seal between the pipe element and the end element on at least one side of the device. The sealing portions of the collar are formed directly adjacent to one another, with the sealing portions having cross-sections of the same or different sizes. Preferably, at least one of the sealing portions on the collar is adapted to the outer dimensions of the coupling portion on the end element and the at least one further sealing portion is adapted to the outer dimensions of the pipe element to be sealed against it.

Preferably, the collar is made of an elastically deformable material, such as silicone, EPDM, rubber, such as NBR, cellular rubber, or other suitable elastomer sealing materials. Preferably, the collar has at least two, preferably three or more cylindrical portions with different diameters. The cylindrical portions on the collar, in relation to the corresponding cylindrical portions on the pipe element and/or the end element, in particular the coupling portion thereof, have a corresponding undersize. The cylindrical portions must be widened in diameter in order to be brought into contact with the corresponding portions on the pipe element and/or the end element. Thereby, form-fitting abutting and also sealing between the contact surfaces of the collar and pipe element and/or end element is achieved.

According to a preferred further development, multiple projections are formed on the inner surface of the collar, which project radially inwards and can be brought into force-fitting and/or preferably form-fitting engagement with the surface of the pipe element. With the aid of the radially inwardly projecting projections, which are preferably formed circumferentially on the inside of the collar, secure positioning of the collar on the device according to the invention is achieved when the projections engage in recesses on the pipe element and/or the coupling portion of the end element. Unintentional loosening of the collar and displacement of the collar along the pipe element and/or the end element is thus advantageously counteracted. In addition, the sealing effect between the collar and the components corresponding therewith (pipe element, end element) can be increased with the aid of the projections projecting on the inside.

Preferably, each cylindrical portion has at least one such projection protruding on the inside, which may be formed only partially or circumferentially on the cylindrical portions in the circumferential direction. The projections are formed as material webs on the inside of the cylindrical portions of the collar, with a preferably circumferential material web cooperating with a recess on the outer surface of the pipe element or with a corresponding recess on the coupling portion of the end element.

According to a preferred embodiment of the device, the collar and/or the pipe element has a receiving portion on the inside for a sealing plug which can be inserted therein, which sealing plug has an opening for leading the line therethrough and is configured to seal with respect to the collar or the pipe element and the line led therethrough. With the aid of the sealing plug, which can be inserted into the receiving portion in particular, on the one hand, a simple sealing with respect to the pipe element or the collar projecting beyond the pipe element at the end and, on the other hand, a simple sealing with respect to the line led through the pipe element are possible. The sealing plug preferably has a cylindrical base body, the outer diameter of which is adapted in particular to the dimension of the pipe element led through the opening in the wall and/or to the collar projecting beyond the end of the pipe element. On its inside, the cylindrical base body preferably has a sealing part that cooperates with the line to be led through the pipe element.

A further development of the collar according to the invention provides that on one of its sealing portions, the collar has a receiving portion for a sleeve pipe that can be brought into contact therewith and/or a tensioning means that locks the collar at least with regard to the pipe element. At least one of the sealing portions is configured to receive and thus act as an adapter for a sleeve pipe that can preferably be sealingly connected to the sleeve. In one embodiment, the receiving portion is arranged at the end of the collar facing away from the end element. The receiving portion can be formed on the outside or inside circumferential surface of the sealing portion. A receiving portion for a tensioning means that locks the collar is provided on at least one of the sealing portions, which can be the same sealing portion or a different sealing portion. By means of the tensioning means, which can be designed as a clamp, the collar is fastened to the outside of the pipe element and/or to the outer circumferential surface of the coupling portion of the end element. In one embodiment, the receiving portion is designed to be cylindrical.

According to a preferred further development, at least one of the sealing portions has an outer circumferential surface that widens in cross-section, in particular conically, in the axial direction. On the sealing portion, which widens in cross-section on the outside, an advantageous tensioning of the sealing portion with respect to the pipe element which is in abutment with the sealing portion on the inside, or to a sealing plug which is in abutment with the sealing portion on the inside and which is used as a seal for a line led through the pipe element, can be achieved by using, for example, a sleeve pipe to be slid onto the sealing portion on the outside. Preferably, the respective sealing portion has an outer circumferential surface that widens conically in the axial direction, whereby bringing into abutment with a preferably cylindrically designed sleeve pipe is achieved in a simplified and uniform manner.

In a preferred further development of the device according to the invention, the collar has an extension portion which adjoins the sealing portion that is smallest in cross-section, which is connected to the sealing portion by means of a predetermined separation point and is configured to receive a sleeve pipe, in particular on the outside. With the aid of the extension portion, which is movable within certain limits relative to the sealing portions of the collar, it is possible to couple a sleeve or protective pipe to the collar, in particular on the outside of the building, which may run at an angle inclined to the longitudinal axis of the lead-through device according to the invention. By means of the extension portion, in particular deviations in the alignment of the opening in the wall portion and in a collar pipe running towards the opening at a deviating angle can be compensated for in a simple manner.

In one possible configuration, the extension portion is preferably connected to the sealing portion with the smallest cross-section via a predetermined separation point. The extension portion can thus be easily separated from the collar, if necessary. In one possible embodiment, the extension portion is designed to be deformable in a radial direction, in particular by the sleeve pipe to be coupled thereto, which can be slid on, in particular on the outside, which simplifies sealing and also the axial alignment of the sleeve pipe and collar with respect to each other. In one embodiment in which the extension portion is designed to receive the sleeve pipe on the inside, the outer circumferential surface of the extension portion is configured to cooperate with a tensioning means for tensioning the extension portion relative to the sleeve pipe received therein.

In a preferred embodiment of the device, the sealing plug has at least one radially inwardly and/or outwardly projecting sealing part, preferably a sealing lip. With the aid of the sealing parts on the outside as well as the inside of the sealing plug, in particular the base body thereof, an advantageously simple sealing effect can be achieved. The inner free cross-section of the sealing plug is adapted to the largest possible line cross-section to be led through the pipe element. The inwardly protruding sealing part is elastic in such a manner that a secure sealing is possible with respect to both the smallest and the largest line cross-section that can be led through the pipe element.

In another configuration of the device, on at least one of the end elements which preferably has a flange body extending at least outside the opening, at least one sealing element is arranged which, in the assembled state, is preferably arranged and tensioned between the flange body of the end element and the wall, and/or a centering aid is provided for at least the radial alignment of the end element with the opening. Preferably, at least the end element arranged on the outer wall surface of the wall has a sealing element which preferably extends annularly along the periphery of the closure unit. The sealing element is arranged or formed on the end element in such a manner that the sealing element can be brought into contact with at least the wall surface surrounding the opening in the radial direction. In one possible embodiment, the sealing element on the end element is configured to also protrude at least partially into the opening in the wall, whereby the sealing effect on the end element equipped with the sealing element is further improved with respect to the wall.

Alternatively or optionally, a centering aid is provided on at least one, preferably both, end elements, by means of which the end elements and thus the device are aligned in the radial direction within the opening. In addition to a preferably central alignment in the opening, whereby the pipe element occupies a preferably uniform distance from the reveal forming the opening, it is also easier to ensure the sealing function by means of the sealing element arranged in particular radially on the outside around the centering aid. Preferably, the centering aid has multiple centering webs arranged circularly around the central region of the end element(s) and projecting on the inside. By means of the centering webs, which protrude into the opening in the wall when the end element is brought into abutment with the wall, the radial offset of the device within the opening is limited. In conjunction with a thermal insulation material to be inserted into the opening, the central arrangement of the device within the opening can create an almost uniform insulating effect around the line to be led through.

According to a preferred configuration, at least one of the end elements has a filling opening and/or vent for a sealing and/or thermal insulation material to be introduced into the opening. By providing at least one filling opening on one of the end elements, it is possible in a simple manner to introduce a flowable thermal insulation material into the receiving space which is formed within the opening after the assembly of the device and which is preferably delimited on both sides by the end elements. Preferably, a filling aid, e.g., in the form of a filling hose, can be connected to the filling opening in a fluid-conducting manner, which facilitates the introduction of a flowable thermal insulation material into the receiving space. As a sealing and/or thermal insulation material, e.g., a two-component foam can be introduced via the filling opening.

In one possible embodiment of the invention, the end element, in addition to its at least one coupling portion for the pipe element, has at least one passage for a media-carrying line. In addition to a line led through the opening by means of the pipe element, a media-carrying line can also be led through the opening in the wall via preferably cylindrical passages formed separately on the end element.

According to a preferred configuration, which provides for force-fitting coupling of the coupling portion with the outer surface of the pipe element, the coupling portion has at least one tensioning part which can be varied in cross-section and which is equipped with a tensioning means which can be brought into operative connection on the outside of the tensioning part for force-fitting engagement with the outer surface of the pipe element. Instead of a form fit by means of coupling elements projecting from the coupling portion and preferably engaging form-fittingly with the surface of the pipe element, the tensioning part can also have multiple coupling elements arranged around the pipe element in the circumferential direction, but which are “only” brought into abutment with the outer surface of the pipe element. By means of a tensioning means, which can be formed, for example, as a clamp, which can be brought separately into operative connection with the tensioning part on the coupling portion, the free cross-section between the preferably multiple coupling elements on the clamping part is reduced such that the tensioning part abuts force-fittingly against the outside of the pipe element. The tensioning force generated by the tensioning means is sufficient to lock the coupling portion in the axial direction along the pipe element.

According to another aspect, the invention relates to a method for installing a device for leading at least one line through an opening in a wall.

The method according to the invention achieves the object described at the beginning, wherein the device is designed according to one of the preferred embodiments described above, comprising the steps of:
providing or making an opening in a building wall;
coupling a first end element to at least one pipe element;
inserting the pipe element coupled to an end element into the opening, wherein the end element connected to the pipe element is preferably brought into abutment with an inner or outer wall surface of the wall,
coupling a second end element to an end of the pipe element opposite the first end element, and
deflecting the pipe element and/or at least one end element in the axial direction by a predetermined (length) dimension by means of a force and bringing the first and second end elements into abutment with the wall surfaces of the wall so that by means of the restoring forces acting on the pipe element and/or the end element, a tensioning of the end elements against the wall is generated, wherein preferably at least one sealing element arranged between the end element and the wall is tensioned.

With the aid of the above-mentioned method steps, the approach according to the invention is pursued to install a device for leading through a line in an opening of a wall portion of a building in a few clear and simple steps. Such a simplified method according to the invention can thus also be reliably carried out by any skilled craftsman, for example in the building shell trade, since errors during assembly are avoided and a satisfactory end product is created in each case after the lead-through device has been assembled.

In a wall portion of a building in which such a device according to the invention is to be installed, an opening is created in a wall portion. This can be done in different ways in the construction sequence. Either the wall is first completely constructed and then the opening in the form of a cutout is created at a later stage, or the wall of the building is constructed with the opening to be provided for the lead-through device in a single operation.

In a next step, a first end element is coupled to a pipe element extending through the opening, which is configured to receive the line to be led through the opening. The end element is only slid onto the pipe element to the extent that the pipe element protrudes from the coupling portion of the end element by a predetermined minimum amount while the remaining length of the pipe element is still sufficient for the opposite end of the pipe element to extend through the wall up to the opposite side. The end element preferably forms a form-fitting connection with the outer surface of the pipe element.

Subsequently, the pipe element coupled to or equipped with the end element is inserted into the opening, wherein the end element connected to the pipe element is preferably brought into abutment with an inner or outer wall surface or at least into the vicinity of such a wall surface.

In the next step, a second end element is then coupled to the opposite end of the pipe element protruding from the wall. When coupling the first and second end elements to the pipe element, the coupling portions of the respective pipe elements are preferably displaced along the outside of the pipe element.

After coupling the second end element to the pipe element, the pipe element and/or at least one of the end elements is deflected in the axial direction by a predetermined amount by means of a force acting on the pipe element and on the end elements. With the deflection, the pipe element is elongated in the direction of its longitudinal axis, whereas on an end element, in particular radially spaced regions thereof, are brought into an axial offset to one another by the deflection. As result, the distance between the end elements or parts thereof is increased. Finally, the first and second end elements are brought into abutment with the wall surfaces. After the tensile/compressive force acting on the pipe element and/or the end elements is removed, a restoring force then acts on the pipe element and/or the end elements in the direction of the wall surfaces due to the elastic deformation of the pipe element and/or the end elements, resulting in the end element(s) being tensioned against the wall surfaces. In a preferred configuration, a sealing element arranged between at least one of the end elements and a wall surface is compressed when the end elements are tensioned against the wall surfaces.

The method according to the invention makes use of the same advantages as the device according to the invention for leading through at least one line. Thus, the preferred embodiments or further developments described for the lead-through device are at the same time also preferred embodiments of the method according to the invention and vice versa, provided that these do not contradict each other, which is why reference is made to the above explanations in this respect in order to avoid repetition.

It follows from the aspects of the invention described above that the lead-through is primarily used as a lead-through through side walls, outer or inner walls, of a building. However, it is also suitable, and in a preferred embodiment is also used, to provide a lead-through through a story or building ceiling.

### BRIEF DESCRIPTION OF THE DRAWINGS

The invention is described in more detail below with reference to a preferred exemplary embodiment with reference to the following figures. In the figures:

FIG. 1: shows a sectional view of a first embodiment of a device for leading a line through a wall;

FIG. 2: shows a partial perspective view of the device according to FIG. 1;

FIG. 3: shows a perspective view of an end element of the device according to the invention;

FIG. 4: shows a perspective view of a collar according to the invention as shown in FIG. 2;

FIG. 5: shows a perspective view of a device according to the invention in the assembled state;

FIG. 6: shows a view of the device according to the invention in the assembled state through an opening running inclined at an angle to the wall surfaces of the wall;

FIG. 7: shows a perspective view of a second exemplary embodiment of a device according to the invention;

FIG. 8: shows a perspective view of the device according to FIG. 7 in the assembled state;

FIGS. 9a,b: show perspective views of an end element according to the invention according to the second exemplary embodiment as shown in FIG. 7;

FIG. 10: shows a first embodiment of a device according to the second aspect of the invention with a collar according to the invention;

FIG. 11: shows a view of an alternative configuration of the device according to FIG. 10 with the collar according to the invention and a plug received on the collar;

FIG. 12: shows a view of a device with an alternative embodiment of a collar according to the invention;

FIG. 13: shows a view of the collar according to the invention as shown in FIG. 12;

FIGS. 14 and 15: show views of devices for the lead-through of lines with further embodiments of collars according to the invention assembled thereon.

### DETAILED DESCRIPTION

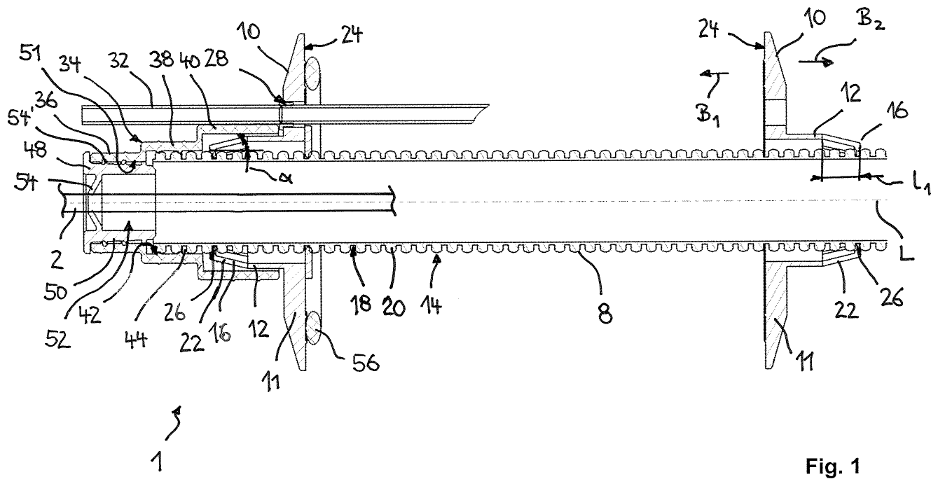

FIG. 1 shows a view of a device for leading at least one line 2 through an opening 4 in a wall 6. The device 1 comprises at least one pipe element 8 for receiving one of the lines 2 to be led through the opening 4 (FIG. 5). The device 1 further comprises two end elements 10 which can be arranged on wall surfaces 6′, 6″ of the wall 6 facing away from each other and can be abutted directly or indirectly against the wall surfaces 6′, 6″. At least one of the end elements 10, preferably both of them, has/have a coupling portion 12 facing inwards towards the pipe element 8, wherein the coupling portion 12 can be brought into abutment or engagement with the outer surface 14 of the pipe element 8 for force-fitting and/or form-fitting coupling.

As can be seen from FIG. 1 in conjunction with FIG. 3, the end element 8 has at least one flange body 11 extending outside the opening 4, on which the coupling portion 12 is arranged with at least one coupling element 16. The coupling element 16 can be brought into form-fitting engagement with the outer surface 14 of the pipe element 8. In the embodiment shown here, multiple coupling elements 16 are arranged on the coupling portion 12 distributed over the circumference of the pipe element 8.

The pipe element 8 has recesses 18 and/or projections 20 on its outer surface 14, wherein the coupling portion 12, in particular the coupling element 16 thereof, is configured to correspond form-fittingly with at least one recess 18 and/or one projection 20 on the pipe element 8.

The pipe element 8 shown here is preferably designed as a corrugated pipe. In the present case, the pipe element 8 and/or at least one of the end elements 10 which can be abutted against the wall surfaces 6′, 6″ of the wall can be elastically deformed axially in the longitudinal direction L of the pipe element in such a manner that, in the assembled state of the device 1, the end elements 10 are pressed in particular against the wall surfaces 6′, 6″ of the wall 6 (FIG. 5) facing away from one another due to the elastic deformation of the pipe element 8 and/or the end element 10.

As FIGS. 1 and 3 further show, the coupling elements 16 are designed as elastically deformable latching hooks 22 and engage, in particular with their end portion 26, in at least one recess 18 on the pipe element or cooperate with a projection 20 on the surface 14 of the pipe element. The coupling elements 16 each have end portions 26 at their free ends, which in the embodiment shown here engage substantially radially inwards into the recesses 18 formed on the pipe element 8 or between the projections 20 projecting outwards on the pipe element 8.

With respect to the longitudinal axis L of the pipe element 8, the coupling elements 16 each extend at an acute angle α on the outside away from the coupling portion 12 on the end elements 10. Due to the orientation of the coupling elements 16 at an acute angle α to the longitudinal axis L, the end elements 10 can be moved with their contact surfaces 24 in a first direction of movement B₁ along the outer surface 14 of the pipe element. However, the coupling elements 16 extending at an angle to the longitudinal axis L have the effect that the end elements 10 cannot be moved in the opposite direction of movement B₂, but instead a locking/latching function is implemented on the end elements 10 designed according to the invention.

Preferably, the coupling elements 16 are evenly distributed around the circumference of the pipe element on the coupling portion 12. In the embodiment shown here, the coupling elements 16 each have an identical length dimension l₁ starting from the coupling portion 12 in the direction of the longitudinal axis L. In an embodiment not shown in more detail, the coupling elements 16 can have different length dimensions starting from the coupling portion 12.

As FIGS. 1, 3 and 5 further show, a filling/venting opening 28 is provided on at least one end element 8, via which a thermal insulation material can be introduced into a receiving space 30 correspondingly delimited in the opening 4 of the wall 6. The filling opening 28 can be equipped with a filling aid 32 in the form of a filling hose, whereby the filling of thermal insulation material into the receiving space 30 is simplified.

As can be seen from FIGS. 1, 2 and 4, the device 1 also has a collar 34 which is preferably to be assembled on the outer wall surface 6′ of the wall and which is designed to be at least partially elastically deformable. The collar 34 can be brought into sealing abutment with the end element 10 on the one hand and with the outer surface 14 of the pipe element 8 on the other hand. In the embodiment shown here, the collar 34 has a three-step configuration with three cylindrical sealing portions 36, 38, 40, with the three sealing portions 36, 38, 40 having different diameters.

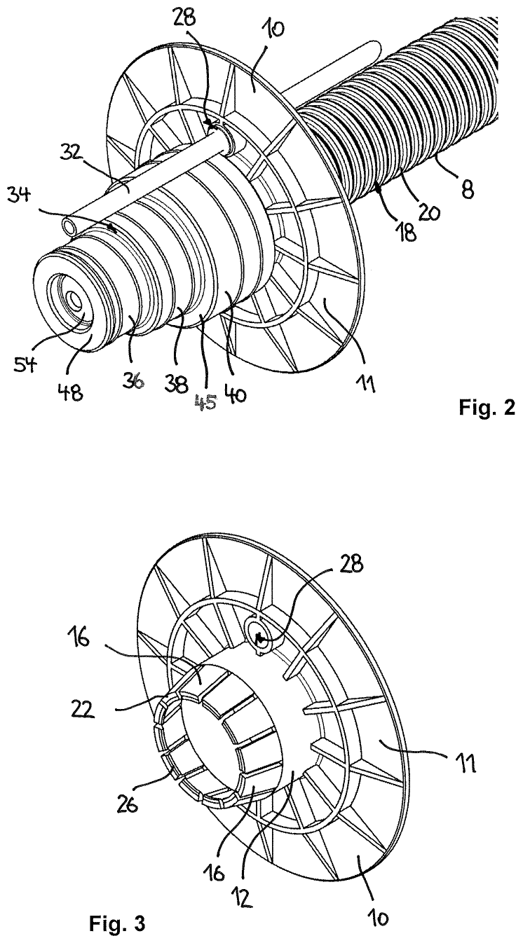

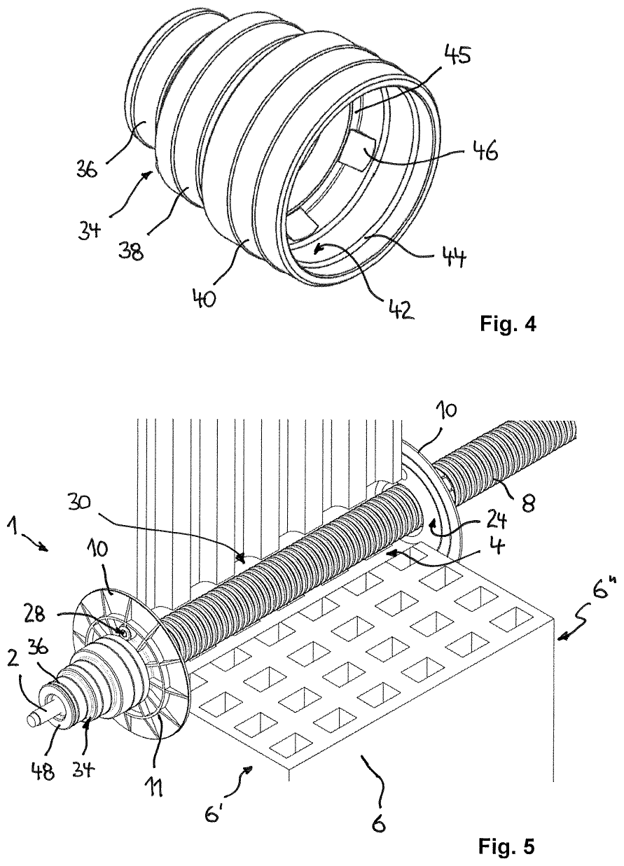

FIGS. 1 and 4 show that multiple projections 44 in the form of inwardly projecting material webs are formed on the inner surface 42 of the sealing portions 36, 38, 40 of the collar 34. Some of the projections 44 are force-fittingly and/or form-fittingly engaged with the pipe element 8 or the coupling portion 12 on the end element 10, for example on the outside of the wall 6. In a transition region 45 (FIGS. 2, 4) between the cylindrical sealing portions 38, 40, multiple pressure wedges 46 are formed on the inside, which effect the coupling elements 16 to remain in engagement with the respective recess 18 and/or the projection 20 after assembly of the device 1 has been completed.

The projections 44 on the inside of the cylindrical portions 36, 38, 40 are formed in the present case as circumferential material webs so that these form-fittingly correspond in particular with the recesses 18 on the pipe element 8 or corresponding recesses on the coupling portion 12.

FIG. 5 shows the device 1 according to the invention in the assembled state within the opening 4 in the wall 6. As can be seen from FIG. 5, the pipe element 8 extends through the opening 4 in the wall 6, with the pipe element 8 projecting with its ends on both sides at the wall surfaces 6′, 6″ of the wall. The end elements 10, which are force-fittingly and/or form-fittingly coupled to the pipe element 8, are in contact with the wall surfaces 6′, 6″ either directly or indirectly, thus with the interposition of one or more components arranged therebetween.

As FIG. 5 further shows, a sealing plug 48 is provided on the device 1, which can be fastened to the collar 34 and/or the pipe element 8. The sealing plug 48, which, as can be seen in connection with FIG. 1, has a cylindrical base body 50, cooperates with its outer side with the inner diameter of the cylindrical sealing portion 36 on the collar 34 or, in sections, with the inner free cross-section of the pipe element 8. The sealing plug 48 is clampingly received in an inside receiving portion 51 (FIG. 1) of the sealing portion 36.

In particular, the sealing plug 48 is configured to seal both against the collar 34 or the pipe element 8 and/or against the line 2 led through the pipe element 8. A passage 52 is formed on the base body 50 for the line 2. In addition, at least one radially inwardly and outwardly projecting sealing part 54, 54′ is/are arranged on the sealing plug 48, which is/are preferably formed as a sealing web or sealing lip.

As illustrated in connection with FIG. 1, a sealing element 56 is associated with the end element 10 arranged, for example, on the outside of the wall 6, which sealing element is pressed together between the end element 10 and the wall 6 by means of the elastic tensioning of the device 1 and by bringing the end element 10 into abutment with the wall surface 6′ of the wall 6 and by applying a compressive force acting at least axially in the direction of the longitudinal axis L of the pipe element 8. In this manner, the sealing function between the end element 10 and the wall 6 is achieved.

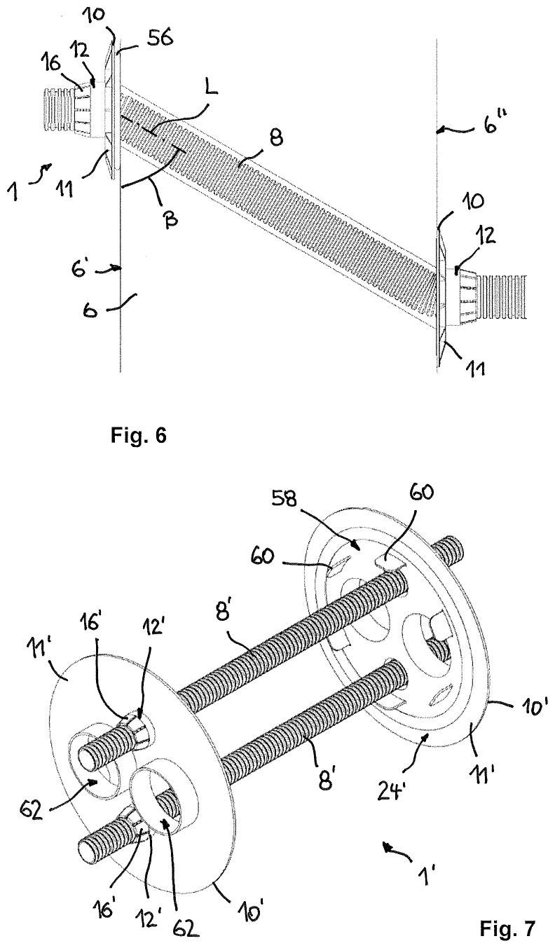

FIG. 6 shows the use of the device 1 when leading a line through an opening 4 in a wall 6, which opening extends at an angle β inclined to the wall surface 6′ of the wall 6. With the configuration of the pipe element 8 as a corrugated pipe, the pipe element can be angled relative to the end elements 10. In order to achieve the angular alignment of the pipe element 8 to the end element 10, the pipe element 8 is compressed in one wall region and stretched in the opposite wall region, as can be seen in FIG. 6. Instead of a corrugated tube, a flexible hose can also be used, on the surface of which recesses and/or projections might be formed, similar to the pipe element 8.

FIG. 7 shows another embodiment of a device F according to the invention which, compared to device 1, has two pipe elements 8′ which are configured to receive lines, not shown in detail, to be led through the opening 4 in a wall. With regard to the basic configuration and function of the device 1′, reference is made to the explanations of the device shown in FIGS. 1 to 6. The end elements 10′ of the device 1′ have a coupling portion 12′ for each of the pipe elements 8′, wherein each coupling portion 12′ with its coupling elements 16′ can be brought into abutment or engagement with the outer surface 14 of the pipe elements 8′ for force-fitting and/or form-fitting coupling.

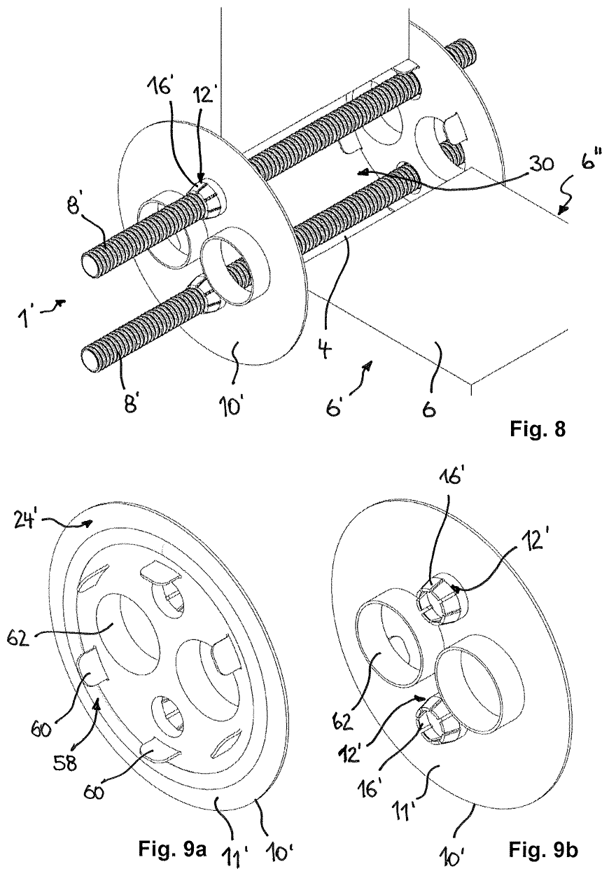

The pipe elements 8′ and/or one of the end elements 10′ that can be abutted against a wall 6 can also be elastically deformed at least axially in the longitudinal direction of the pipe element 8′, so that during assembly of the device 1 in the opening 4 in a wall 6 shown in FIG. 8, the pipe elements 8′ can be elongated in the axial direction or at least one of the end elements can be deformed in the axial direction by bringing it into abutment with a respectively associated wall surface 6′, 6″ in such a manner that with the final fixing of the end element(s) along the pipe elements 8′, restoring forces act within the pipe elements 8′ or the end elements 10′ so that in the assembled state, the end element 10′ generates a contact force on the wall 6.

FIGS. 9a and 9b show an end element 10′ from the inside and outside, respectively. As the present embodiment shows, a centering aid 58, having multiple protruding centering webs 60 arranged around the central region of the end element 10′, is arranged on the contact surface 24′ associated with the wall surface. The two coupling portions 12′ formed on the outside of the end element 10′ also have multiple coupling elements 16′ arranged distributed around the circumference of the pipe element 8′ to be coupled thereto.

In the embodiment shown here, two passages 62 for media-carrying lines (not shown) to be led through the opening 4 are also formed on the end elements 10′.

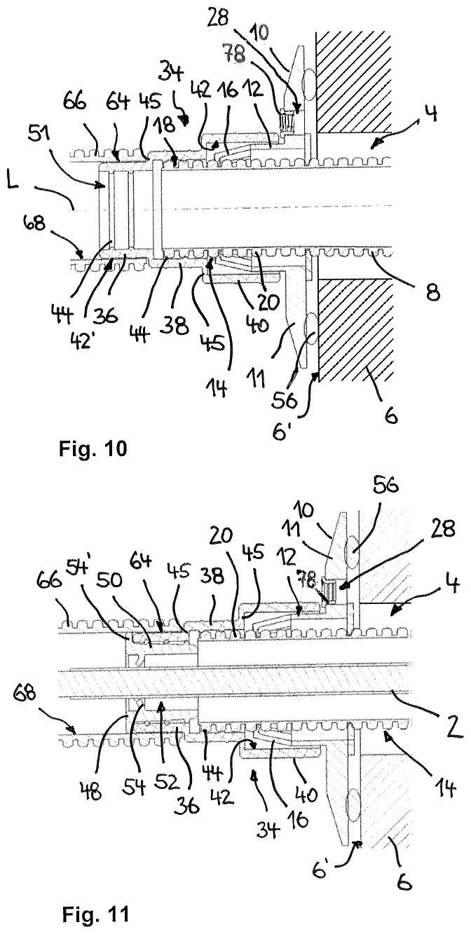

In FIG. 10, a second aspect of the present invention is illustrated in the form of an at least partially elastically deformable collar 34 brought into sealing abutment with the end element 10 on the one hand and with the outer surface 14 of the pipe element 8 on the other hand. In particular, the collar 34 is assembled on the outer wall surface 6′ of the wall 6. In the embodiment shown, the collar 34 is formed with three steps, thus has three cylindrical sealing portions 36, 38, 40. The sealing portions 36, 38, 40 each have different diameters with respect to one another and are connected to one another via primarily radially extending transition regions 45.

Similar to the first aspect, multiple projections 44 are provided on the inner surface 42 of the sealing portions 36, 38, 40 of the collar 34, which are configured to be brought into sealing abutment with any components brought into contact therewith, such as the pipe element 8 or the coupling portion 12 on the end element 10. In particular, some of the projections 44 are in force-fitting and/or form-fitting engagement with recesses 18 formed on the pipe element 8 or the coupling portion 12 of the end element 10.

In the transition region 45 between the cylindrical sealing portions 38, 40, as can be seen in connection with FIG. 4, multiple pressure wedges 46 can be formed on the inner surface 42. The pressure wedges 46 effect that after completed assembly of the device 1, the coupling elements 16 on the coupling portion 12 of the end element 10 remain in engagement with the respective recesses 18 and/or projections 20 on the pipe element 8 in the region of the opening 4 on the wall 6.

As can also be seen from FIG. 10, the sealing portion 36 with the smallest cross-section has a receiving portion 64 which is configured to cooperate with a sleeve or protective pipe 66 which is sealingly slid with its inside 68 onto the circumferential surface 42′ of the cylindrical sealing portion 36. Preferably, the sealing portion 36 has an oversize relative to the inside of the sleeve/protective pipe 66 so that the sealing portion 36 is compressed in the radial direction when brought into contact with the sleeve/protective pipe 66.

FIG. 11 shows another configuration of a device 1 with a collar 34 that is similar to the embodiment shown in FIG. 10. In addition to the sleeve/protective pipe 66 surrounding the cylindrical sealing portion 36 on the outside, a sealing plug 48, which in the embodiment shown here is received on a receiving portion 64 on the inside of the collar 34, cooperates with the inner surface 42 of the sealing portion 36. In an alternative embodiment, the sealing plug 48 can also be received on the inner free cross-section of the pipe element 8 led through the opening 4 in the wall 6.

The sealing plug 48 is configured to seal with respect to the collar 34 and also with respect to the line 2 led through the pipe element 8. The sealing plug 48 has a cylindrical base body 50 in which a passage 52 is formed for the line 2 to be led through the opening 4. In addition, arranged on the sealing plug 48 is/are at least one sealing part 54, 54′ projecting radially inwards and outwards, respectively, which is/are preferably in the form of a sealing web or sealing lip.

With the aid of the sealing plug 48 cooperating with the collar 34, the sealing effect of the collar is achieved with respect to the pipe element 8 and the line 2 led through the opening 4, which line can be, for example, a data or media line, in particular for a heat pump system or an air conditioning system.

The end element 10 shown in FIGS. 10-12, 14 and 15 can also have a filling opening 28 with which a filling aid 32 shown, e.g., in FIG. 1 or 2, can be coupled, via which a sealing or thermal insulation material can be introduced into the receiving space 30 delimited by the opening 4. As shown in FIGS. 10, 11, 12 and 14, the filling opening 28 can be closed by a closing plug 78. The closing plug 78 must be removed before filling in the sealing or thermal insulation material.

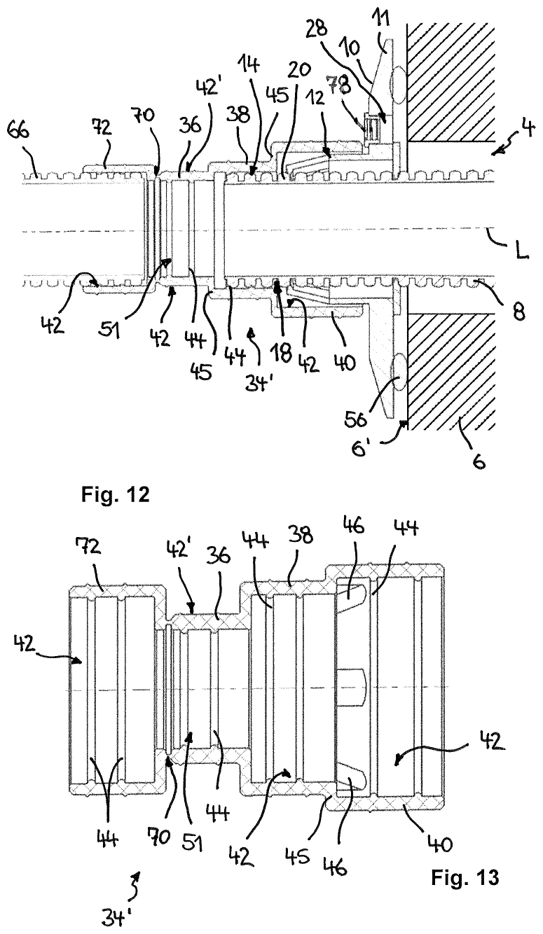

FIGS. 12 and 13 show another embodiment of a collar 34′ cooperating with the device 1 and having an extension portion 72 adjoining the sealing portion 36 having the smallest cross-section. The extension portion 72 is connected to the sealing portion 36 by means of a predetermined separation point 70. The extension portion 72 is configured to receive a sleeve/protective pipe 66 on the outside. In a preferred embodiment, the extension portion 72, similar to the sealing portions 36, 38, 40, also has multiple projections 44 on its inner surface 42, which are designed as material webs projecting inwards and preferably formed to extend circumferentially in the circumferential direction of the extension portion 72. In one possible embodiment, the projections 44 are again force-fittingly and/or form-fittingly in engagement with the sleeve/protective pipe 66, wherein the extension portion 72, due to the elastically deformable configuration of the collar 34′, can be oriented with its longitudinal axis L inclined at an angle to the longitudinal axis L of the pipe element 8.

FIG. 13 shows a sectional view of the collar 34′ according to the invention, wherein it is illustrated that the extension portion 72 can be separated via the predetermined separation point 70, which forms a material weakening from the sealing portion 36 to the extension portion 72. Similar to the collar 34 described for the first aspect of the invention, the collar 34′ has multiple pressure wedges 46 projecting on the inside in the transition region 45 between the cylindrical sealing portions 38, 40. By means of the pressure wedges 46 it is effected that the coupling elements 16 shown in FIG. 12 on the coupling portion 12 of the end element 10 cannot automatically disengage from the recesses 18 or projections 20 (FIGS. 10, 12) for a force-fitting connection with the pipe element 8.

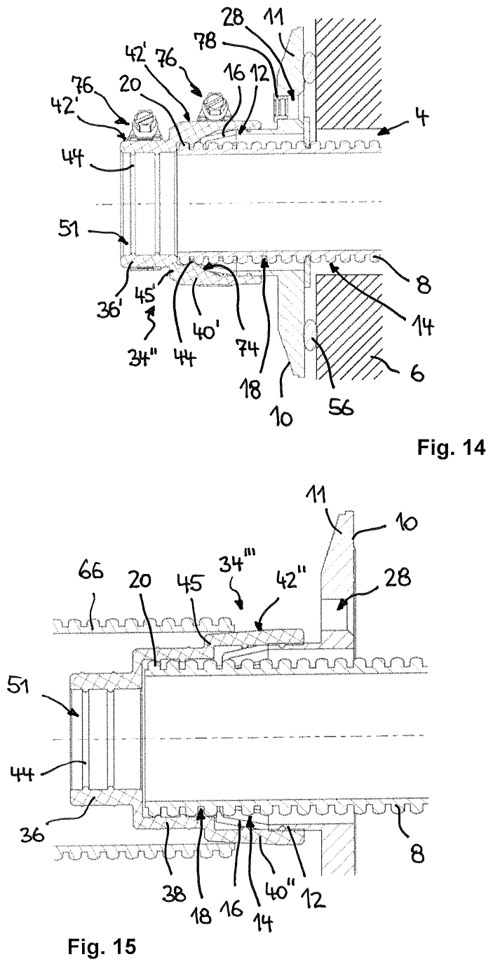

FIG. 14 shows a device 1 for leading at least one line 2 (FIG. 11) through an opening 4 in a wall in connection with another configuration of a collar 34″ according to the invention. In the embodiment shown here, the collar 34″ has a two-step configuration with exactly two cylindrical sealing portions 36′, 40′. The two-step collar 34′ has a sealing portion 40′ which is configured for bringing it into engagement with the coupling portion 12 on the end element 10 and for locking the collar 34″ relative to the outer surface 14 of the pipe element 8 in a combined manner. The sealing portion 40′ has at least one projection 44 which enters into a force-fitting or form-fitting connection with a recess 18 or a projection 20 of the pipe element 8. In addition, a pressure surface 74 formed to correspond with the coupling elements 16 on the coupling portion 12 is provided on the sealing portion 40′, which pressure surface is preferably formed to be conical along a portion in the axial direction for abutting against the coupling elements 16 of the coupling portion 12.

The sealing portion 36′ is directly connected to the sealing portion 40′ by means of a transition region 45′. In addition, the sealing portion 36′ is arranged directly adjoining the free end of the pipe element 8 in the axial direction.

The sealing portion 36′ can be equipped with an inside receiving portion 51 for a sealing plug 48 to be received thereon, as shown by way of example in FIG. 11. Tensioning means 76 in the form of clamps are arranged on the outer circumferential surfaces 42′ of the sealing portions 36′, 40′ in the embodiment shown here. With the aid of the tensioning means 76, the collar 34″ can be fixed to the pipe element 8 or the coupling portion 12 of the end element 10. The tensioning means 76 arranged on the outside of the sealing portion 36′ preferably serves to lock a sleeve/protective pipe 66 (not shown in detail) inserted into the receiving portion 51 of the sealing portion 36′. Alternatively, instead of the sleeve/protective pipe 66, a sealing plug 48 (FIG. 11) can also be inserted into the receiving portion 51 on the sealing portion 36′.

FIG. 15 shows another embodiment of a collar 34″′ which can be combined with a device 1 and which is similar to the collar 34 in FIGS. 10 and 11. In contrast to the cylindrical configuration of the outer circumferential surface 42′ on the collar 34, the sealing portion 40″, which cooperates at least partially with the coupling portion 12 on the end element 10, has an outer contour on its outer circumferential surface 42′ that widens from the transition region 45 between the sealing portions 38 and 40″ in the direction of the end of the collar 34″′ that approaches the end element 10. The outer diameter of the sealing portion 40″ preferably widens slightly, in particular conically, from the transition region 45 in the direction of the end of the collar 34″′ associated with the end element.

Otherwise, the collar 34″′ has an at least similar, almost identical, configuration compared to the embodiments shown in FIGS. 1 to 5 and 10 and 11. In order to avoid unnecessary repetitions, reference is made to the above explanations of collar 34 with regard to the configuration of collar 34″′. Due to the conical outer contour of the sealing portion 40″, a sleeve/protective pipe 66 adapted to the diameter of the sealing portion 40″ can be slid over the outside of the sealing portion 40″ in a simplified manner, the sleeve/protective pipe 66 having a clamping effect on the sealing portion 40″ due to its higher material rigidity compared to the collar 34″′.

In the receiving portion 51, in turn, a sealing plug 48 can be arranged on the sealing portion 36 of the collar 34″′ so as to be operatively connected thereto in a sealing manner.

The embodiments of a collar 34 to 34″′ described as the second aspect of the invention, although not shown here in the drawings, can be used in conjunction with a device 1 when leading a line through an opening 4 in a wall 6 at an angle β inclined to the wall surface 6′. By means of at least one of the collars 34 to 34″′, the coupling portion 12 with its coupling elements 16 arranged on the outside of the building can also be sealed with the outer surface 14 of the pipe element 8 via such a collar.

Identical or similar components are designated with the same reference signs.

### REFERENCE LIST

1, 1′ device
2 line
4, opening
6 wall
6′, 6″ wall surface
8, 8′ pipe element
10, 10′ end element
11, 11′ flange body
12, 12′ coupling portion
14 surface of pipe element
16, 16′ coupling element
18 recesses
20 projection
22 latching hook
24, 24′ contact surface of end element
26 end portion
28 filling/venting opening
30 receiving space
32 filling aid
34, 34′, 34″, 34″′ collar
36, 36′, 38 sealing portion
40, 40′, 40″ sealing portion
42 collar surface
42′ circumferential surface
44 projection
45, 45′ transition region
46 pressure wedge
48 sealing plug
50 base body
51 receiving portion on the inside
52 passage
54, 54′ sealing part
56 sealing element
58 centering aid
60 centering web
62 passage
64 receiving portion on the outside
66 sleeve/protective pipe
68 inside
70 predetermined separation point
72 extension portion
74 pressure surface
76 tensioning means
78 closing plug
α, β angle
B₁, B₂ direction of movement
L longitudinal axis
l₁ length dimension

1. A device for leading at least one line through an opening in a surface, the device comprising:
a pipe element for receiving the line to be led through the opening; and
at least one end element, configured to abut the surface,
each end element having a coupling portion facing inwardly toward the pipe element;
wherein each coupling portion is configured to be brought into abutment with an outer surface of the pipe element for fitting coupling,
wherein at least one of the pipe element or the at least one end element is axially elastically deformable in a longitudinal direction of the pipe element such that the at least one end element presses against the surface when the device is an assembled state.

2. The device according to claim 1,
wherein each coupling portion comprises at least one coupling element configured to be brought into form-fitting engagement with the outer surface of the pipe element.

3. The device according to claim 1,
wherein the pipe element is a corrugated pipe including at least one of a plurality of recesses or a plurality of projections on the outer surface of the pipe element, and each coupling portion is configured to form-fittingly correspond with at least one of the at least one of the plurality of recesses or the plurality of projections.

4. The device according to claim 1,
wherein the pipe element is operably disposed at an angle in between 0° and 70° relative to the surface.

5. The device according to claim 2,
wherein each coupling element is an elastically deformable latching hook configured to be latched to at least one recess on the pipe element.

6. The device according to claim 1,
wherein each coupling portion comprises a plurality of coupling elements arranged on the coupling portion and disposed around a circumference of the pipe element.

7. The device according to claim 1,
wherein each coupling portion comprises a first group of coupling elements having a first length and a second group of coupling elements having a second length, the first and second groups of coupling elements being disposed around a circumference of the pipe element; and
wherein the first length is different from the second length.

8. The device according to claim 1,
further comprising a partially elastically deformable collar having at least two axially adjoining sealing portions, the sealing portions each being configured to be brought into sealing abutment with one of the end elements and with the outer surface of the pipe element.

9. The device according to claim 8,
wherein the collar comprises a plurality of projections disposed on an inner surface of the collar and projecting radially inwardly, the plurality of projections being configured to operatively be brought into fitting engagement with the outer surface of the pipe element.

10. The device according to claim 9,
wherein each projection is a material web and is configured to correspond with a recess of the pipe element.

11. The device according to a claim 8,
wherein an inside of at least one of the pipe element or the collar includes a receiving portion for receiving a sealing plug; and
wherein each sealing plug includes at least one passage configured for receiving the line therethrough in a sealing manner.

12. The device according to claim 8,
wherein the collar includes a receiving portion on one of the sealing portions; and
wherein the receiving portion is operable to receive at least one of a sleeve pipe or a tensioning means, the tensioning means being configured to lock the collar with the pipe element.

13. The device according to claim 8,
wherein at least one of the sealing portions has an outer circumferential surface which widens in cross-section in an axial direction.

14. The device according to claim 8,
wherein one of the sealing portions has a cross-section smaller than the other sealing portions; and wherein the collar has an extension portion adjoining the sealing portion with the smallest cross-section, the extension portion being configured to receive a sleeve pipe.

15. The device according to claim 11,
wherein each sealing plug has at least one radially projecting sealing part.

16. The device according to claim 1, further comprising:
a sealing element disposed on one of the at least one end elements, the sealing element being arranged and tensioned between the end element having the sealing element and the surface when the device is assembled; and
a centering aid configured to radially align the end element having the sealing element with the opening.

17. The device according to claim 1,
wherein each end element includes a passage for receiving a media-carrying line.

18. The device according to claim 1,
wherein each coupling portion includes at least one tensioning part in whichwith a variable cross-section and having a tensioning means which can be brought into operative connection on an outside of the tensioning part for force-fitting engagement with the outer surface of the pipe element.

19. A method for installing a device for leading a line through a wall, the method comprising the steps of:
making an opening in the wall;
coupling a first end element to a first end of a pipe element;
inserting the pipe element into the opening such that the first end element abuts a first surface of the wall;
coupling a second end element to a second end of the pipe element opposite the first end element; and
extending at least one of the pipe element, the first end element, or the second end element a predetermined length in an axial direction and bringing the first and second end elements into abutment with the first surface and a second surface and such that restoration of at least one of the pipe element, the the first end element or the second end element tensions the end elements against the wall.

20. (canceled)

21. The method of claim 19, wherein a sealing element disposed between one of the end elements and the wall is tensioned.
